(19) United States
(12) Patent Application Publication
(10) Pub. No.: US 2014/0324446 A1
(43) Pub. Date: Oct. 30, 2014

(54) METHOD FOR SELECTING A BARIATRIC SURGERY

(71) Applicant: Gus J. Slotman, Moorestown, NJ (US)

(72) Inventor: Gus J. Slotman, Moorestown, NJ (US)

(21) Appl. No.: 14/258,464

(22) Filed: Apr. 22, 2014

Related U.S. Application Data
(60) Provisional application No. 61/815,799, filed on Apr. 25, 2013.

(51) Int. Cl. G06F 19/00

(52) U.S. Cl. CPC G06F 19/345
USPC 705/2

(57) ABSTRACT

This invention relates to the selection of an appropriate bariatric surgery for a patient based upon baseline patient parameters.

This application claims the benefit of U.S. Provisional Application No. 61/815,799 filed Apr. 25, 2013, which is herein incorporated by reference in its entirety.

### BACKGROUND

Obesity is a complex medical disorder of appetite regulation and metabolism resulting in excessive accumulation of adipose tissue mass. Typically defined as a body mass index (BMI) of 30 kg/m² or more, obesity is a world-wide public health concern that is associated with cardiovascular disease, diabetes, certain cancers, respiratory complications, osteoarthritis, gallbladder disease, decreased life expectancy, and work disability. The primary goals of obesity therapy are to reduce excess body weight, improve or prevent obesity-related morbidity and mortality, and maintain long-term weight loss.

Treatment modalities typically include lifestyle management, pharmacotherapy, and surgery. Treatment decisions are made based on severity of obesity, seriousness of associated medical conditions, patient risk status, and patient expectations. Notable improvements in cardiovascular risk and the incidence of diabetes have been observed with weight loss of 5-10% of body weight, supporting clinical guidelines for the treatment of obesity that recommend a target threshold of 10% reduction in body weight from baseline values.

However, while prescription anti-obesity medications are typically considered for selected patients at increased medical risk because of their weight and for whom lifestyle modifications (diet restriction, physical activity, and behavior therapy) alone have failed to produce durable weight loss, approved drugs have had unsatisfactory efficacy for severely obese subjects, leading to only −3-5% reduction in body weight after a year of treatment.

Bariatric surgery may be considered as a weight loss intervention for patients at or exceeding a BMI of 40 kg/m². Patients with a BMI≧35 kg/m² and an associated serious medical condition are also candidates for this treatment option. Unfortunately, postoperative complications commonly result from bariatric surgical procedures, including bleeding, embolism or thrombosis, wound complications, deep infections, pulmonary complications, and gastrointestinal obstruction; reoperation during the postoperative period is sometimes necessary to address these complications. Rates of reoperation or conversion surgery beyond the postoperative period depend on the type of bariatric procedure and can range from 17% to 31%. Intestinal absorptive abnormalities, such as micronutrient deficiency and protein-calorie malnutrition, also are typically seen with bypass procedures, requiring lifelong nutrient supplementation. Major and serious adverse outcomes associated with bariatric surgery are common, observed in approximately 4 percent of procedures performed (including death in 0.3 to 2 percent of all patients receiving laparoscopic banding or bypass surgeries, respectively).

Given the risks associated with bariatric surgery, it would be of significant benefit to know the outcome of a bariatric surgery prior to conducting the surgery. The present invention meets this need in the art.

### SUMMARY OF THE INVENTION

The present invention is a method for selecting a bariatric surgery for a patient by obtaining one or more baseline parameters of a patient; generating from the baseline parameters a patient profile; using statistical tests to compare the patient profile with a control profile comprising independent variables for subjects who have responded positively to a bariatric surgery; identifying whether the patient profile has independent variables of the control profile for the bariatric surgery; and selecting a bariatric surgery for the patient. In some embodiments, the bariatric surgery comprises open gastric bypass, laparoscopic gastric bypass, adjustable gastric band, sleeve gastrectomy, or duodenal switch. In other embodiments, the patient baseline parameters and outcome are combined with a database containing the control profiles.

### DETAILED DESCRIPTION OF THE INVENTION

It has now been found that individual patient weight, weight loss, presence or absence of co-morbidities, and adverse events up to 24 months after open gastric bypass, laparoscopic gastric bypass, adjustable gastric band, duodenal switch, and sleeve gastrectomy can be predicted from baseline pre-operative data from an individual patient. Using the present invention, morbidly obese subjects can enter demographic, physiologic and medical information into the models described herein and know before surgery what outcome would be obtained for open gastric bypass, laparoscopic gastric bypass, adjustable gastric banding, sleeve gastrectomy, or duodenal switch. Alternatively stated, using the method of this invention, it can be determined prior to surgery how much weight the subject would lose and whether or not co-morbidities such as sleep apnea, hypertension, diabetes, GERD, and the like will resolve with each of the five operations, thus allowing the subject and the subject's surgeon to choose objectively which operation would be best for the subject. In this respect, a subject can decide which surgery is most appropriate for him or her based on weight loss predictions, predicted resolution of co-morbidities the subject had at baseline, and predictions of post-operative adverse events, i.e. complications. These predicted outcomes can be taken into consideration individually or together to select the appropriate surgery for the subject.

From a Bariatric Outcomes Longitudinal Database (BOLD) of 181,157 patients who had undergone one of five different bariatric surgery operations, 166,601 patients who had at least one post-operative follow-up visit were analyzed with the objective of building regression models that would predict specific outcomes for individual morbidly obese patients who were trying to decide which weight loss procedure to have. A randomization program was applied to divide the database into a modeling group (n=124,053) and a validation group (n=42,548). Analyzing the modeling population, linear regression was used to find the best predictors to examine continuous variables like weight and weight gain at each time point (2, 6, 12, 18 and 24 months). The list of variables used in this analysis included age, abdominal hernia, African American, Alcohol Use, Angina assessment, Asthma, Back Pain, Congestive heart failure (CHF), Caucasian, Cholelithiasis, Depression, GERD (gastroesophageal reflex disease), Gender, Height (cm), Hypertension, Intercept, Liver Disease, Mental Health diagnosis, Musculoskeletal disease, Obesity Hypoventilation syndrome, Psychosocial Impairment, Pulmonary Hypertension, Stress Urinary Incontinence, Weight (Kg), full time employment, and treatment. Models for continuous variables were built using linear regression. Logistic Regression was used to find the best predictors to examine dichotomous variables adverse events at 0, 0-6 and 0-12 months and co-morbidities at 2, 6, 12, 18 and 24 months. All models were built using forward selection to choose the independent variables that would best predict the individual outcome. All interactions were examined between treatment and the other independent variables, significant interactions with treatment remained in the model. Independent categorical variables with a low incidence rate were collapsed to create larger groups. Independent variables, used in the logistic regression models, that caused a quasi-complete separation of data points due to a low incidence rate were not used in any of the models. When the modeling process was completed, models were validated prospectively by entering baseline information from the patients in the validation group into the models and then comparing the predicted results to the actual observed outcomes. To examine model fit, for the linear regression models, the coefficient of determination (r2) was examined and for dichotomous dependent variables by Receiver Operating Characteristics/Area Under the Curve (ROC/AUC) were examined for the model set.

After the modeling process was completed, baseline, pre-operative data, which fulfilled requirements for the models from the validation group, were entered into each model. Sensitivity and specificity assessed predicted versus observed correlations for dichotomous dependent variables. Pearson Correlation coefficient evaluated continuous dependent variables.

Predictive models for complications of surgery, >25% weight loss, and resolution of co-morbidities of obesity performed with ROC/AUC as high as 0.919 up to 12 months after surgery. Models for continuous dependent variables, including weight and weight loss, were confirmed at r2 values as high as 0.888.

Validation of predicted versus observed results included sensitivity of 50% to 92% at 12 months, and specificity of 80% to 98% (Table 1). Pearson Correlation Coefficients for validated continuous variables were 0.96 at 2 months and 0.81 at 24 months after surgery. Specificities were 0.99 for predicting post-operative adverse events, while sensitivities were variable.

TABLE 1

| Dichotomous | | | | | |
|---|---|---|---|---|---|
| Dependent | Time (Months) | | | | |
| Variables | 2 | 6 | 12 | 18 | 24 |
| Cholelithiasis | | | | | |
| Specificity | 98.83 | 98.34 | 97.62 | 97.42 | 97.21 |
| NPV | 99.33 | 98.72 | 97.94 | 97.80 | 96.82 |
| Sensitivity | 97.13 | 94.70 | 91.78 | 90.94 | 86.93 |
| PPV | 95.12 | 93.18 | 90.62 | 89.51 | 88.39 |
| GERD | | | | | |
| Specificity | 81.05 | 80.27 | 87.07 | 87.25 | 86.65 |
| NPV | 96.74 | 88.76 | 83.58 | 83.22 | 83.21 |
| Sensitivity | 95.12 | 74.81 | 49.82 | 47.32 | 44.77 |
| PPV | 73.76 | 60.48 | 56.78 | 55.35 | 51.49 |
| Glucose | | | | | |
| Metabolism/ | | | | | |
| Diabetes | | | | | |
| Specificity | 88.59 | 91.85 | 91.59 | 91.36 | 93.97 |
| NPV | 99.36 | 93.26 | 93.93 | 93.40 | 92.93 |
| Sensitivity | 98.39 | 74.87 | 72.14 | 69.14 | 60.28 |
| PPV | 75.40 | 70.83 | 64.55 | 62.60 | 64.27 |
| Hypertension | | | | | |
| Specificity | 85.21 | 74.58 | 80.92 | 80.02 | 79.30 |
| NPV | 91.73 | 92.86 | 85.28 | 85.80 | 87.34 |
| Sensitivity | 92.44 | 92.61 | 77.91 | 79.15 | 79.56 |
| PPV | 86.40 | 73.86 | 72.09 | 71.56 | 68.37 |
| Liver Disease | | | | | |
| Specificity | 99.20 | 98.86 | 98.41 | 98.47 | 98.05 |
| NPV | 99.29 | 99.15 | 99.12 | 98.89 | 98.94 |
| Sensitivity | 88.55 | 85.22 | 84.79 | 79.39 | 77.58 |
| PPV | 87.24 | 81.15 | 75.42 | 73.50 | 64.97 |
| Obstructive | | | | | |
| Sleep Apnea | | | | | |
| Specificity | 93.68 | 87.64 | 88.01 | 89.94 | 90.95 |
| NPV | 84.80 | 87.57 | 86.73 | 85.83 | 85.96 |
| Sensitivity | 73.99 | 87.57 | 64.06 | 59.05 | 50.76 |
| PPV | 88.32 | 74.22 | 64.06 | 68.04 | 62.86 |
| Support Group | | | | | |
| Attendance | | | | | |
| Specificity | 99.87 | 99.98 | 99.94 | 99.89 | 99.97 |
| NPV | 85.24 | 85.46 | 85.82 | 88.24 | 88.18 |
| Sensitivity | 0.38 | 0.05 | 0.19 | 0 | 0.23 |
| PPV | 33.82 | 33.33 | 36.36 | 0 | 50 |
| Nausea and | | | | | |
| Vomiting | | | | | |
| Specificity | | 99.94 | 99.97 | | |
| NPV | | 97.29 | 97.03 | | |
| Sensitivity | | 0.32 | 0.07 | | |
| PPV | | 12.5 | 6.67 | | |
| Abdominal | | | | | |
| Adverse Event | | | | | |
| Specificity | | 99.92 | 99.97 | 99.97 | |
| NPV | | 93.98 | 93.15 | 93.15 | |
| Sensitivity | | 0.57 | 0.13 | 0.13 | |
| PPV | | 31.37 | 26.67 | 26.67 | |
| Organ Failure | | | | | |
| and Sepsis | | | | | |
| Specificity | | 99.82 | 99.85 | | |
| NPV | | 99.03 | 98.99 | | |
| Sensitivity | | 8.91 | 7.69 | | |
| PPV | | 34.92 | 36.45 | | |
| Any Adverse | | | | | |
| Event | | | | | |
| Specificity | | 99.92 | 99.92 | | |
| NPV | | 88.74 | 87.36 | | |
| Sensitivity | | 0.52 | 0.51 | | |
| PPV | | 45.3 | 49.72 | | |
| Congestive | | | | | |
| Heart Failure | | | | | |
| Specificity | 99.84 | 99.79 | 99.71 | 99.68 | 99.48 |
| NPV | 98.92 | 98.94 | 98.98 | 99.18 | 99.02 |
| Sensitivity | 40.35 | 40.62 | 37.61 | 42.47 | 25 |
| PPV | 81.92 | 77.64 | 68.22 | 65.96 | 38.71 |
| Abdominal | | | | | |
| hernia | | | | | |
| Specificity | 99.56 | 99.45 | 99.16 | 99.27 | 99.15 |
| NPV | 99.56 | 99.47 | 99.21 | 98.94 | 98.7 |
| Sensitivity | 93.31 | 90.03 | 85.99 | 79.2 | 75.27 |
| PPV | 91.72 | 89.61 | 85.22 | 84.62 | 82.35 |

| Continuous | | | | | |
|---|---|---|---|---|---|
| Dependent | | | | | |
| Variables | | | | | |
| Weight/ | Time (Months) | | | | |
| Weight Loss | 2 | 6 | 12 | 18 | 24 |
| Pearson | 9.95861 | 9.93236 | 0.87549 | 0.8368 | 0.81114 |
| Correlation | <0.0001 | <0.0001 | <0.0001 | <0.0001 | <0.0001 |
| Coefficient | | | | | |
| for | | | | | |
| predicted | | | | | |
| versus | | | | | |
| observed | | | | | |

Having demonstrated that baseline parameters such as weight, weight loss, presence or absence of co-morbidities, and adverse events can be used to predict outcomes for bariatric surgery, the present invention can be used in selecting or prescribing an appropriate surgical approach for a morbidly obese patient considering weight loss intervention via bariatric surgery. In accordance with the method of this invention, a bariatric surgery is selected by obtaining one or more baseline parameters of a patient; generating from the baseline parameters a patient profile; using statistical tests to compare the patient profile with a control profile comprising independent variables for subjects who have responded positively to a bariatric surgery; identifying whether the patient profile has independent variables of the control profile for the bariatric surgery; and selecting an appropriate bariatric surgery for the patient based upon whether the patient profile has or shares a significant number of independent variables of the control profile for a particular bariatric surgery. Desirably, the patent profile is compared with control profiles for each of the bariatric surgeries disclosed herein.

Patient profiles of the present invention are generated from one or more baseline parameters. Patient parameters, for purposes of this invention, may include demographics, comorbidities, medications, procedures, weight loss and maintenance, physiological variables, and complications.

Exemplary demographic variables which may be selected for inclusion in a patient profile include, but are not limited to, age, sex, or race. Comorbidities particularly include cholelithiasis (i.e., a subject with asymptomatic gallstones as well as symptomatic gallstones), gastroesophageal reflux disease (GERD), diabetes or a glucose metabolism disorder, hypertension, chronic heart failure (CHF), liver disease (e.g., a subject who has had a hepatomegaly or non-normal liver function test), obstructive sleep apnea (e.g., sleep apnea requiring oral appliance, significant hypoxia, or oxygen-dependence), abdominal hernia (e.g., any history of symptomatic or asymptomatic abdominal hernia). Comorbidities can also include, e.g., alcohol abuse, HIV, dialysis, neutropenia, solid tumors, hematologic malignancies, chronic renal failure, abdominal skin pannus, angina, BMI, back pain, DVT/PE, depression, fibromyalgia, or gout.

Examples of physiologic variables which may be selected for inclusion in a patient profile include, but are not limited to, physical examination, vital signs, and clinical laboratory tests. More specifically, physiologic variables selected may include height, weight, temperature, MAP, heart rate, diastolic blood pressure, and systolic blood pressure of the patient. In addition, complete blood count, platelet count, prothrombin time, partial thromboplastin time, fibrin degradation products and D-dimer, serum creatinine, lactic acid bilirubin, AST, ALT, and/or GGT can be measured. Heart rate, respiratory rate, blood pressure and urine output can also be monitored. Chest X-rays and bacterial cultures can also performed as clinically indicated.

In particular embodiments, the baseline parameters include age, height (cm), weight (kg), employments status, gender, race (Caucasian, African American or Asian), alcohol use, angina assessment, asthma, back pain, cholelithiasis, CHF, depression, gastroesophageal reflux disease, diabetes, a glucose metabolism disorder, hypertension, liver disease, obstructive sleep apnea, musculoskeletal disease, obesity hypoventilation syndrome, psychosocial impairment, pulmonary hypertension, stress unitary incontinence, mental health status and/or abdominal hernia.

Some or all of these patient parameters are preferably determined at baseline (i.e., before intervention), and daily thereafter where applicable, and are entered into a computer program and a patient profile comprising one or more of the patient parameters is generated. As one of skill in the art will appreciate from this disclosure, as patient profiles are generated for more patients and additional data are collected for these parameters, it may be found that some parameters in this list of examples are less predictive than others. Those parameters identified as less predictive in a larger patient population need not be included in all patient profiles. In this respect, certain embodiments of the present invention include combining or entering the patient baseline parameters and outcome into a database containing a collection of patient baseline parameters and outcomes, which in turn are used in the generation of one or more control profiles.

For purposes of this invention, a “control profile” can be generated from a database containing mean values for selected patient parameters from a population of patients. A control profile for selecting an appropriate bariatric surgery is a control profile, as defined supra, that includes independent variables linked to a treatment identified to be effective in those patients with similar conditions from which the control profile was generated.

As will be understood by those of skill in the art upon reading this disclosure, patient profiles can be generated from all of the patient parameters discussed supra. Alternatively, patient profiles can be based upon only a portion of the patient parameters. Since the patient parameters for each patient, as well as the control profiles, are stored in a database, various patient profiles comprising different patient parameters can be generated for a single patient and compared to an established control profile comprising the same parameters. The ability of these various profiles to be predictive can then be determined via statistical analysis.

Continuous, normally distributed variables are evaluated using analysis of variance. When appropriate, statistical comparisons between subgroups are made using the t-test or the chi-squared equation for categorical variables. Data analysis and/or comparisons are preferably carried out on a computer with results available on a monitor, printout or other readout.

The physician or another individual of skill in the art uses the patient profile as a guide to prescribe a bariatric surgery selected from gastric bypass, laparoscopic gastric bypass, adjustable gastric band, duodenal switch, and sleeve gastrectomy based upon whether the patient profile matches the control profile of the a bariatric surgery. This method is therefore a way to enhance the likelihood of a positive or successful bariatric surgery outcome. A positive outcome for a bariatric surgery can include weight loss, reduced morbidity and/or reduced adverse events.

### Example 1

### Independent Baseline Variables of Diabetes Models

Models for co-morbidities were prepared including a model for diabetes (glucose metabolism). The model coefficient estimates and significance of variables at 2, 6, 12, 18 and 24 months after duodenal switch surgery, laparoscopic gastric bypass and sleeve gastrectomy are presented in Tables 2, 3 and 4, respectively.

TABLE 2

| | | | | |
|---|---|---|---|---|
| | Class | | Std | Prob. |
| Variable | Val10 | Estimate | Error | Chi Sq. |

2 Months

| | | | | |
|---|---|---|---|---|
| Intercept | | 0.4256 | 1.6193 | 0.7927 |
| Glucose Metabolism | 0 | 2.5862 | 0.1928 | <.0001 |
| Caucasian | 0 | −0.5628 | 0.1888 | 0.0029 |
| Weight (kg) | | −0.0117 | 0.00357 | 0.0011 |
| African American | 0 | −0.5499 | 0.2458 | 0.0253 |
| Height (cm) | | 0.0234 | 0.0107 | 0.0287 |
| Angina | 0 | −0.5261 | 0.2235 | 0.0186 |
| Alcohol Use | 0 | −0.0976 | 0.2070 | 0.6372 |
| Alcohol Use | 1 | 0.4529 | 0.2457 | 0.0653 |
| Alcohol Use | 2 | 0.3845 | 0.2455 | 0.1173 |

6 Months

| | | | | |
|---|---|---|---|---|
| Intercept | | 2.5403 | 0.3055 | <.0001 |
| Glucose Metabolism | 0 | 2.1185 | 0.2619 | <.0001 |
| Stress Uninary Incon. | 0 | 0.4559 | 0.1709 | 0.0077 |
| Stress Uninary Incon. | 12 | 0.2815 | 0.1879 | 0.1341 |
| Length of Stay | | −0.0521 | 0.0219 | 0.0173 |

12 Months

| | | | | |
|---|---|---|---|---|
| Intercept | | 0.0885 | 0.9551 | 0.9262 |
| Glucose Metabolism | 0 | 2.1917 | 0.5508 | <.0001 |
| Gout hyperurea | 0 | 1.0055 | 0.2910 | 0.0005 |
| Full-Time | | 1.0216 | 0.4125 | 0.0133 |
| Stress Uninary Incon. | 0 | 0.7764 | 0.2655 | 0.0035 |
| Stress Uninary Incon. | 12 | 0.1328 | 0.2765 | 0.6310 |
| Caucasian | 0 | −0.6017 | 0.2455 | 0.0142 |
| Pulmonary Hypertension | 10 | 1.5486 | 0.9023 | 0.0861 |

18 Months

| | | | | |
|---|---|---|---|---|
| Intercept | | 7.0902 | 104.3 | 0.9458 |
| Glucose Metabolism | 0 | 7.0053 | 104.3 | 0.9464 |
| Angina | 0 | 1.1836 | 0.5926 | 0.0458 |

24 Months

| | | | | |
|---|---|---|---|---|
| Intercept | | 8.0999 | 102.9 | 0.9373 |
| Glucose Metabolism | 0 | 6.4657 | 102.9 | 0.9499 |

TABLE 3

| | | | | |
|---|---|---|---|---|
| | Class | | Std | Prob. |
| Variable | Val10 | Estimate | Error | Chi Sq. |

2 Months

| | | | | |
|---|---|---|---|---|
| Intercept | | 2.7180 | 0.1846 | <.0001 |
| Glucose Metabolism | 0 | 2.9172 | 0.0350 | <.0001 |
| AGE | | −0.0172 | 0.00141 | <.0001 |
| Caucasian | 0 | −0.1376 | 0.0176 | <.0001 |
| Ischemic Heart Dis. | 0 | 0.1922 | 0.0306 | <.0001 |
| CHF | 10 | 0.2830 | 0.0746 | 0.0001 |
| Weight (kg) | | −0.00173 | 0.000540 | 0.0014 |
| Liver disease | 0 | −0.1102 | 0.0443 | 0.0129 |
| Liver disease | 1 | 0.0786 | 0.0570 | 0.1681 |
| Liver disease | 2 | 0.1287 | 0.0780 | 0.0991 |
| Length of stay | | −0.0369 | 0.00801 | <.0001 |
| GERD | 0 | −0.0870 | 0.0467 | 0.0624 |
| GERD | 1 | −0.00235 | 0.0529 | 0.9645 |
| GERD | 2 | −0.0177 | 0.0566 | 0.7547 |
| GERD | 3 | 0.0564 | 0.0489 | 0.2487 |
| GERD | 4 | −0.0447 | 0.0773 | 0.5628 |
| Alcohol Use | 0 | −0.0542 | 0.0382 | 0.1555 |
| Alcohol Use | 1 | 0.0552 | 0.0433 | 0.2023 |
| Alcohol Use | 2 | 0.0617 | 0.0463 | 0.1829 |
| Peripheral Vas | 10 | 0.1665 | 0.0639 | 0.0092 |
| Fibromyalgia | 1 | −0.0963 | 0.0374 | 0.0100 |
| Gout, hyperurea | 0 | −0.0792 | 0.0320 | 0.0134 |
| Lipids | 0 | 0.0393 | 0.0259 | 0.1299 |
| Lipids | 1 | −0.00646 | 0.0347 | 0.8523 |
| Lipids | 2 | 0.0308 | 0.0470 | 0.5117 |
| Musculoskeletal | 0 | −0.0574 | 0.0212 | 0.0068 |
| Musculoskeletal | 12 | 0.0273 | 0.0213 | 0.2014 |
| Functional status | 0 | 0.1939 | 0.0683 | 0.0045 |
| Functional status | 1 | −0.0181 | 0.0876 | 0.8360 |
| Functional status | 2 | −0.0181 | 0.1280 | 0.8875 |

6 Months

| | | | | |
|---|---|---|---|---|
| Intercept | | 3.7757 | 0.2401 | <.0001 |
| Glucose Metabolism | 0 | 2.4850 | 0.0476 | <.0001 |
| AGE | | −0.0228 | 0.00183 | <.0001 |
| Ischemic Heart Dis. | 0 | 0.1958 | 0.0350 | <.0001 |
| Caucasian | 0 | −0.1186 | 0.0220 | <.0001 |
| Alcohol Use | 0 | −0.1439 | 0.0479 | 0.0027 |
| Alcohol Use | 1 | 0.0446 | 0.0542 | 0.4105 |
| Alcohol Use | 2 | 0.0280 | 0.0582 | 0.6304 |
| Weight (kg) | | −0.00277 | 0.000737 | 0.0002 |
| Lipids | 0 | −0.0372 | 0.0326 | 0.2536 |
| Lipids | 1 | −0.0227 | 0.0432 | 0.5995 |
| Lipids | 2 | 0.1992 | 0.0598 | 0.0009 |
| Length of stay | | −0.0260 | 0.00771 | 0.0007 |
| Cholelithiasis | 0 | −0.1485 | 0.0347 | <.0001 |
| Cholelithiasis | 12 | 0.2146 | 0.0600 | 0.0003 |
| Substance Abuse | 0 | 0.3832 | 0.1390 | 0.0058 |
| Lower Extr. Edema | 0 | 0.0673 | 0.0190 | 0.0004 |
| Stress Uninary Incon. | 0 | −0.0796 | 0.0323 | 0.0136 |
| Stress Uninary Incon. | 12 | 0.0738 | 0.0354 | 0.0369 |
| Gout, hyperurea | 0 | −0.1097 | 0.0390 | 0.0050 |
| Full time | | 0.0971 | 0.0358 | 0.0067 |
| Fibromyalgia | 1 | −0.1074 | 0.0460 | 0.0196 |
| Peripheral Vas | 10 | 0.1469 | 0.0715 | 0.0399 |
| Musculoskeletal | 0 | −0.0691 | 0.0262 | 0.0084 |
| Musculoskeletal | 12 | 0.00267 | 0.0260 | 0.9183 |
| Gender | Female | −0.0502 | 0.0236 | 0.0336 |
| Angina | 0 | 0.0969 | 0.0459 | 0.0346 |

12 Months

| | | | | |
|---|---|---|---|---|
| Intercept | | 4.0481 | 0.2561 | <.0001 |
| Glucose Metabolism | 0 | 2.2221 | 0.0659 | <.0001 |
| AGE | | −0.0217 | 0.00250 | <.0001 |
| Lower Extr Edema | 0 | 0.1318 | 0.0260 | <.0001 |
| African American | 0 | 0.1527 | 0.0556 | 0.0060 |
| Ischemic Heart Dis. | 0 | 0.2189 | 0.0428 | <.0001 |
| Lipids | 0 | 0.000187 | 0.0462 | 0.9968 |
| Lipids | 1 | 0.1234 | 0.0612 | 0.0438 |
| Lipids | 2 | 0.0808 | 0.0844 | 0.3385 |
| Alcohol Use | 0 | −0.1674 | 0.0676 | 0.0132 |
| Alcohol Use | 1 | 0.0917 | 0.0761 | 0.2279 |
| Alcohol Use | 2 | 0.0137 | 0.0830 | 0.8693 |
| Length of Stay | | −0.0260 | 0.00963 | 0.0069 |
| Cholelithiasis | 0 | −0.1564 | 0.0480 | 0.0011 |
| Cholelithiasis | 12 | 0.2210 | 0.0838 | 0.0084 |
| Functional Status | 0 | 0.3415 | 0.0972 | 0.0004 |
| Functional Status | 1 | −0.0747 | 0.1247 | 0.5490 |
| Functional Status | 2 | −0.0396 | 0.1781 | 0.8242 |
| Musculoskeletal | 0 | −0.1425 | 0.0379 | 0.0002 |
| Musculoskeletal | 12 | −0.0457 | 0.0365 | 0.2103 |
| Weight (kg) | | −0.00205 | 0.000927 | 0.0272 |
| Caucasian | 0 | −0.0865 | 0.0405 | 0.0329 |
| Back Pain | 0 | 0.0551 | 0.0260 | 0.0341 |
| Fibromyalgia | 1 | −0.1285 | 0.0646 | 0.0466 |

18 Months

| | | | | |
|---|---|---|---|---|
| Intercept | | 3.3868 | 0.3541 | <.0001 |
| Glucose Metabolism | 0 | 2.1704 | 0.1282 | <.0001 |
| AGE | | −0.0144 | 0.00480 | 0.0027 |
| Full time | | 0.2569 | 0.0988 | 0.0093 |
| CHF | 10 | 0.4697 | 0.1953 | 0.0162 |
| Length of Stay | | −0.0418 | 0.0200 | 0.0366 |
| Abdominal skin Pan | 0 | −0.2218 | 0.0919 | 0.0158 |
| Lower Extr Edema | 0 | 0.1123 | 0.0499 | 0.0245 |

24 Months

| | | | | |
|---|---|---|---|---|
| Intercept | | 3.3953 | 0.4680 | <.0001 |
| Glucose Metabolism | 0 | 2.6540 | 0.2524 | <.0001 |
| AGE | | −0.0166 | 0.00587 | 0.0046 |
| African American | 0 | 0.2930 | 0.0994 | 0.0032 |
| Angina | 0 | 0.3637 | 0.1240 | 0.0034 |
| PeripheralVas | 10 | 0.4770 | 0.1815 | 0.0086 |
| Alcohol Use | 0 | 0.0203 | 0.1695 | 0.9048 |
| Alcohol Use | 1 | 0.4048 | 0.1925 | 0.0354 |
| Alcohol Use | 2 | 0.3208 | 0.2118 | 0.1299 |
| Hypertension | 10 | 0.1424 | 0.0721 | 0.0484 |

TABLE 4

| | | | | |
|---|---|---|---|---|
| | Class | | Std | Prob. |
| Variable | Val10 | Estimate | Error | Chi Sq. |

2 Months

| | | | | |
|---|---|---|---|---|
| Intercept | | 2.0331 | 0.3661 | <.0001 |
| Glucose Metabolism | 0 | 3.0789 | 0.0947 | <.0001 |
| AGE | | −0.0166 | 0.00487 | 0.0007 |
| Caucasian | 0 | −0.1311 | 0.0631 | 0.0377 |
| CHF | 10 | 0.5444 | 0.2701 | 0.0438 |

6 Months

| | | | | |
|---|---|---|---|---|
| Intercept | | 3.2513 | 0.8289 | <.0001 |
| Glucose Metabolism | 0 | 2.5320 | 0.1551 | <.0001 |
| Hypertension | 10 | 0.1699 | 0.0853 | 0.0464 |
| Weight (kg) | | −0.00822 | 0.00243 | 0.0007 |
| Lipids | 0 | 0.2654 | 0.1408 | 0.0594 |
| Lipids | 1 | 0.0660 | 0.1848 | 0.7208 |
| Lipids | 2 | −0.0377 | 0.2819 | 0.8937 |
| Functional Status | 0 | 0.8046 | 0.3895 | 0.0388 |
| Functional Status | 1 | 1.2668 | 0.4543 | 0.0053 |
| Functional Status | 2 | −1.2114 | 0.9859 | 0.2191 |
| DVT_PE | 0 | 0.7406 | 0.2826 | 0.0088 |
| DVT_PE | 12 | −0.0769 | 0.4163 | 0.8535 |
| Psycho Impair | 0 | 0.2494 | 0.0956 | 0.0091 |
| Pulmonary Hyperten | 10 | −1.0797 | 0.4354 | 0.0131 |
| Back Pain | 0 | −0.1607 | 0.0724 | 0.0265 |
| Obesity Hypoven | 0 | 0.4730 | 0.2268 | 0.0370 |
| AGE | | −0.0179 | 0.00745 | 0.0163 |
| Caucasian | 0 | −0.2092 | 0.0933 | 0.0250 |

12 Months

| | | | | |
|---|---|---|---|---|
| Intercept | | 3.1598 | 0.3483 | <.0001 |
| Glucose Metabolism | 0 | 2.1465 | 0.2163 | <.0001 |
| Lipids | 0 | −0.2050 | 0.2168 | 0.3444 |
| Lipids | 1 | 0.7097 | 0.3195 | 0.0263 |
| Lipids | 2 | −0.0237 | 0.4337 | 0.9564 |
| GOUT, Hyperurea | 0 | −0.4645 | 0.2432 | 0.0561 |

18 Months

| | | | | |
|---|---|---|---|---|
| Intercept | | 1.7344 | 0.4078 | <.0001 |
| Glucose Metabolism | | 2.1696 | 0.3785 | <.0001 |
| Full time | 0 | 1.2517 | 0.4797 | 0.0091 |

24 Months

| | | | | |
|---|---|---|---|---|
| Intercept | | −21.6350 | 144.7 | 0.8812 |
| Glucose Metabolism | 0 | 1.2566 | 0.4557 | 0.0058 |
| Gender | Female | 2.8101 | 0.9947 | 0.0047 |
| Asthma | 0 | −3.9066 | 144.1 | 0.9784 |
| Asthma | 12 | −5.8082 | 144.1 | 0.9678 |
| Stress Urinary inc | 0 | 1.7218 | 0.8433 | 0.0412 |
| Stress Urinary inc | 12 | 0.7596 | 0.7808 | 0.3307 |
| Height (cm) | | 0.1580 | 0.0801 | 0.0485 |

All models were built using forward selection to choose the independent variables that would best predict the individual outcome. All interactions were examined between treatment and the other independent variables, significant interactions with treatment remained in the model. When the modeling process was completed, models were validated prospectively by entering baseline information from the patients in the validation group into the models and then comparing the predicted results to the actual observed outcomes. To examine model fit, for the linear regression models, the coefficient of determination (r2) was examined and for dichotomous dependent variables by Receiver Operating Characteristics/Area Under the Curve (ROC/AUC) were examined for the model set. The results of the model and validated set are presented in Tables 5 and 6, respectively.

TABLE 5

| Months After | | Prob. Chi | |
|---|---|---|---|
| Surgery | Surgery | Sq. | AUC |
| 2 | Duodenal switch | 0.2054 | 0.905 |
| 6 | Duodenal switch | 0.6600 | 0.851 |
| 12 | Duodenal switch | 0.0018 | 0.889 |
| 18 | Duodenal switch | 1.0000 | 0.804 |
| 24 | Duodenal switch | | 0.775 |
| 2 | Laparoscopic RYGB | 0.0047 | 0.927 |
| 6 | Laparoscopic RYGB | 0.3889 | 0.892 |
| 12 | Laparoscopic RYGB | 0.9967 | 0.875 |
| 18 | Laparoscopic RYGB | 0.7257 | 0.859 |
| 24 | Laparoscopic RYGB | 0.3644 | 0.871 |
| 2 | Sleeve gastrectomy | 0.6181 | 0.952 |
| 6 | Sleeve gastrectomy | 0.9487 | 0.933 |
| 12 | Sleeve gastrectomy | 0.9270 | 0.887 |
| 18 | Sleeve gastrectomy | 0.6933 | 0.913 |
| 24 | Sleeve gastrectomy | 0.0708 | 0.931 |

TABLE 6

| Months After | | Prob. Chi | |
|---|---|---|---|
| Surgery | Surgery | Sq. | AUC |
| 2 | Duodenal switch | 0.0910 | 0.936 |
| 6 | Duodenal switch | 0.5909 | 0.894 |
| 12 | Duodenal switch | 0.9550 | 0.897 |
| 18 | Duodenal switch | 1.0000 | 0.818 |
| 24 | Duodenal switch | | 0.811 |
| 2 | Laparoscopic RYGB | 0.6220 | 0.924 |
| 6 | Laparoscopic RYGB | 0.1446 | 0.892 |
| 12 | Laparoscopic RYGB | 0.8039 | 0.875 |
| 18 | Laparoscopic RYGB | 0.2763 | 0.862 |
| 24 | Laparoscopic RYGB | 0.9834 | 0.858 |
| 2 | Sleeve gastrectomy | 0.5403 | 0.952 |
| 6 | Sleeve gastrectomy | 0.7123 | 0.930 |
| 12 | Sleeve gastrectomy | 0.9667 | 0.923 |
| 18 | Sleeve gastrectomy | 0.9940 | 0.897 |
| 24 | Sleeve gastrectomy | 0.9429 | 0.984 |

### Example 2

### Predicting Outcomes in Individual Patients Before Undergoing Bariatric Surgery

Patient characteristics including age, abdominal hernia, African American race, Alcohol Use, Angina assessment, Asthma, Back Pain, CH), Caucasian, Cholelithiasis, Depression, GERD, Gender, Height (cm), Hypertension, Intercept, Liver Disease, Mental Health diagnosis, Musculoskeletal disease, Obesity Hypoventilation syndrome, Psychosocial Impairment, Pulmonary Hypertension, Stress Urinary Incontinence, Weight (Kg), full time employment, and treatment, were screened to determine whether these variables could be used to predicted the desired outcomes of full time employment.

Once the models were complete and validated with validation statistics, a computer program was generated that allowed a user to enter weighted variables including age, height (cm), weight (kg), employments status, gender, race (Caucasian, African American or Asian), alcohol use, angina assessment, asthma, back pain, cholelithiasis, CHF, depression, GERD, hypertension, liver disease, musculoskeletal disease, obesity hypoventilation syndrome, psychosocial impairment, pulmonary hypertension, stress unitary incontinence, abdominal hernia, and mental health, and calculate the models for each. Once calculated, the program provides an output that gives predicted results for an individual patient.

By way of illustration, Table 7 provides results from the model predictions for an individual.

TABLE 7

| | Predicted Outcome, | | | | |
|---|---|---|---|---|---|
| | Months After Surgery | | | | |
| Surgery | 2 | 6 | 12 | 18 | 24 |

Abdominal Hernia^{a}

| | | | | | |
|---|---|---|---|---|---|
| Adjustable Gastric Banding | 1 | 2 | 3 | 3 | 3 |
| Duodenal Switch | 1 | 6 | 25 | 40 | 30 |
| Laparoscopic RYGB | 1 | 2 | 3 | 3 | 3 |
| Open RYGB | 2 | 3 | 6 | 10 | 10 |
| Sleeve Gastrectomy | 1 | 3 | 6 | 8 | 6 |

Congestive Heart Failure^{a}

| | | | | | |
|---|---|---|---|---|---|
| Adjustable Gastric Banding | 12 | 9 | 8 | 13 | 5 |
| Duodenal Switch | 29 | 18 | 12 | 20 | 11 |
| Laparoscopic RYGB | 15 | 10 | 8 | 11 | 5 |
| Open RYGB | 13 | 9 | 7 | 14 | 4 |
| Sleeve Gastrectomy | 15 | 10 | 8 | 14 | 4 |

Cholelithiasis^{a}

| | | | | | |
|---|---|---|---|---|---|
| Adjustable Gastric Banding | 1 | 3 | 7 | 1 | 2 |
| Duodenal Switch | 26 | 38 | 60 | 25 | 21 |
| Laparoscopic RYGB | 2 | 3 | 8 | 2 | 2 |
| Open RYGB | 1 | 2 | 5 | 1 | 2 |
| Sleeve Gastrectomy | 3 | 5 | 12 | 3 | 3 |

GERD^{a}

| | | | | | |
|---|---|---|---|---|---|
| Adjustable Gastric Banding | 4 | 5 | 5 | 7 | 8 |
| Duodenal Switch | 5 | 8 | 6 | 9 | 12 |
| Laparoscopic RYGB | 3 | 3 | 3 | 4 | 5 |
| Open RYGB | 3 | 4 | 5 | 6 | 9 |
| Sleeve Gastrectomy | 4 | 5 | 5 | 7 | 9 |

Glucose Metabolism^{a}

| | | | | | |
|---|---|---|---|---|---|
| Adjustable Gastric Banding | 29 | 36 | 20 | 16 | 15 |
| Duodenal Switch | 27 | 26 | 8 | 8 | 5 |
| Laparoscopic RYGB | 30 | 29 | 12 | 8 | 8 |
| Open RYGB | 31 | 30 | 16 | 12 | 11 |
| Sleeve Gastrectomy | 29 | 29 | 13 | 11 | 9 |

Hypertension^{a}

| | | | | | |
|---|---|---|---|---|---|
| Adjustable Gastric Banding | 48 | 76 | 50 | 13 | 46 |
| Duodenal Switch | 31 | 50 | 18 | 4 | 17 |
| Laparoscopic RYGB | 33 | 52 | 24 | 4 | 21 |
| Open RYGB | 39 | 59 | 34 | 9 | 32 |
| Sleeve Gastrectomy | 37 | 60 | 30 | 7 | 27 |

Liver Disease^{a}

| | | | | | |
|---|---|---|---|---|---|
| Adjustable Gastric Banding | 1 | 1 | 1 | 1 | 0 |
| Duodenal Switch | 4 | 9 | 7 | 2 | 2 |
| Laparoscopic RYGB | 1 | 1 | 2 | 1 | 0 |
| Open RYGB | 3 | 4 | 4 | 1 | 1 |
| Sleeve Gastrectomy | 2 | 2 | 2 | 1 | 1 |

Obstructive Sleep Apnea^{a}

| | | | | | |
|---|---|---|---|---|---|
| Adjustable Gastric Banding | 94 | 96 | 95 | 94 | 91 |
| Duodenal Switch | 95 | 96 | 94 | 93 | 89 |
| Laparoscopic RYGB | 94 | 95 | 92 | 90 | 85 |
| Open RYGB | 95 | 95 | 94 | 91 | 86 |
| Sleeve Gastrectomy | 94 | 95 | 93 | 91 | 87 |

Support Group Attendance^{a}

| | | | | | |
|---|---|---|---|---|---|
| Adjustable Gastric Banding | 10 | 10 | 11 | 8 | 5 |
| Duodenal Switch | 17 | 18 | 19 | 16 | 11 |
| Laparoscopic RYGB | 14 | 15 | 16 | 12 | 9 |
| Open RYGB | 14 | 14 | 15 | 11 | 9 |
| Sleeve Gastrectomy | 13 | 13 | 14 | 11 | 7 |

Weight

| | | | | | |
|---|---|---|---|---|---|
| Adjustable Gastric Banding | 362 | 343 | 327 | 315 | 308 |
| Duodenal Switch | 338 | 280 | 232 | 219 | 214 |
| Laparoscopic RYGB | 347 | 297 | 258 | 243 | 241 |
| Open RYGB | 342 | 396 | 253 | 231 | 235 |
| Sleeve Gastrectomy | 349 | 311 | 279 | 270 | 273 |

Weight Loss

| | | | | | |
|---|---|---|---|---|---|
| Adjustable Gastric Banding | 38 | 57 | 73 | 85 | 92 |
| Duodenal Switch | 62 | 120 | 168 | 181 | 186 |
| Laparoscopic RYGB | 53 | 103 | 142 | 157 | 159 |
| Open RYGB | 58 | 104 | 147 | 169 | 165 |
| Sleeve Gastrectomy | 51 | 89 | 121 | 130 | 127 |

BMI

| | | | | | |
|---|---|---|---|---|---|
| Adjustable Gastric Banding | 264 | 264 | 264 | 264 | 264 |
| Duodenal Switch | 264 | 264 | 264 | 264 | 264 |
| Laparoscopic RYGB | 264 | 264 | 264 | 264 | 264 |
| Open RYGB | 264 | 264 | 264 | 264 | 264 |
| Sleeve Gastrectomy | 264 | 264 | 264 | 264 | 264 |

^{a}Numbers are the % probability of having that condition at that time.

What is claimed is:

1. A method for selecting a bariatric surgery for a patient comprising
(a) obtaining one or more baseline parameters of a patient;
(b) generating from the baseline parameters a patient profile;
(c) using statistical tests to compare the patient profile with a control profile comprising independent variables for subjects who have responded positively to a bariatric surgery;
(d) identifying whether the patient profile has independent variables of the control profile for the bariatric surgery; and
(e) selecting a bariatric surgery for the patient.

2. The method of claim 1, wherein the bariatric surgery comprises open gastric bypass, laparoscopic gastric bypass, adjustable gastric band, sleeve gastrectomy, or duodenal switch.

3. The method of claim 1, further comprising combining the patient baseline parameters and outcome with a database comprising the control profiles.
